(19) United States
(12) Patent Application Publication
(10) Pub. No.: US 2009/0097107 A1
(43) Pub. Date: Apr. 16, 2009

(54) Microscope

(76) Inventor: Peter J. Walla, Braunschweig (DE)

Correspondence Address: GREER, BURNS & CRAIN, 300 S WACKER DR, 25TH FLOOR, CHICAGO, IL, 60606, US

(21) Appl. No.: 11/990,461

(22) PCT Filed: Aug. 16, 2006
(86) PCT No.: PCT/EP2006/065369

§ 371 Date: Jun. 6, 2008

(30) Foreign Application Priority Data
Aug. 17, 2005 (DE) 102005039153.2

(51) Int. Cl. G02B 21/00; G02B 27/30

(52) U.S. Cl. 359/370; 359/641

(57) ABSTRACT

The present invention relates to a device for analyzing particles in the nanometer or micrometer range by optical measurement of light irradiated onto the sample containing particles. Accordingly, the device of the present invention can also be referred to as a microscope. The microscope device comprises an arrangement for detection of changes of the optical properties of the sample volume, e.g. changes in absorption and/or in refractive index in space and/or in time, using an interferometer arrangement of a collimated light beam or of split beams (3, 4) generated by a beam splitter (2). The wave front of the light focused into the sample is influenced by inhomogeneities of the sample, and the resultant wave front fluctuations are subsequently measured in a wave front analyser (8), which preferably is a deep nulling interferometer.

The present invention relates to a device and a process for analyzing particles in the nanometer or micrometer range by optical measurement of light irradiated onto the sample containing particles, using interferometry for the detection of sample inhomogeneities. Accordingly, the device of the present invention can also be referred to as a microscope.

### STATE OF THE ART

EP 1411345 A1 describes an apparatus for multi-photon excitation in confocal fluorometry of biological samples using pulsed lasers for generating the irradiation of the exciting wavelength. The laser beam is split and the resulting split beams are coupled into the back aperture of a microscope objective at different angles. From the microscope objective, the split beam laser beams are focussed into the sample volume. The same microscope objective is used for guiding projected beams emitted from the sample. Fluorescence generated within the sample by the excitation irradiation is separated from the common light path by a beam splitter. For measurement, each fluorescence signal is separately projected onto a detector. In accordance with the measurement of fluorescent light emitted from a sample upon irradiation with and the excitation wavelength, presence of fluorescing molecules is required.

US 2002/0118422 A1 discloses the use of a Mach-Zehnder interferometer arrangement for compensating the polarization mode dispersion. The Mach-Zehnder interferometer comprises a beam splitter producing a first and a second output lightpath, which are received in an optical combiner. From measurement of the polarization mode dispersion differential delay between the first and second principal states of polarization along the respective first and second lightpaths, a combined output signal is generated which can be used to control the compensation within one arm of the Mach-Zehnder interferometer.

### OBJECTS OF THE INVENTION

In view of the known drawbacks of devices for analyzing biological samples, which usually require labelling of at least one biological reactant with a fluorescent dye for single molecule fluorescence detection or require chemical linkage in the case of surface plasmon resonance measurements, it is desirable to provide an analytical method and the device for performing the method for optical analysis of small particles without the requirement for chemical derivatization, e.g. without the requirement for linkage of a fluorescent dye molecule or linkage to a surface.

Accordingly, it is an object of the present invention to provide a method and a device for performing the method for optical analysis of small molecules in the nanometer to micrometer range, without being restricted to the measurement of fluorescing samples and without the requirement for chemical derivatization of samples.

### GENERAL DESCRIPTION OF THE INVENTION

The present invention achieves the above-mentioned objects by providing a device comprising an arrangement for detection of changes of the optical properties of the sample volume such as optical inhomogeneities, e.g. changes in absorption and/or in refractive index in space and/or in time, using an interferometer device arranged within a collimated light beam or within split beams generated by a beam splitter. In general, the light beam or split beams are focused into a sample and the wave front of the light passing through the sample is influenced by inhomogeneities of the sample, and the resultant wave front fluctuations are subsequently measured in a wave front analyser, which preferably is a deep nulling interferometer. The electronic measurement signals obtainable from the wave front analyser can be displayed. Preferably, the measurement signals from the wave front anlayser, representing the wave front fluctuations, are subjected to a correlational analysis, e.g. using an algorithm according to the following equation:

G(τ)= [symbol] Δx_{OPD}(t)·Δx_{OPD}(t+τ) [symbol] ∝ [symbol] (\sqrt{D(t)}− [symbol] \sqrt{D(t)} [symbol] )·(\sqrt{D(t+τ)}− [symbol] \sqrt{D(t)} [symbol] )

[symbol]

wherein τ is the correlation time, D is the light intensity, Δx_{OPD} is the optical path length difference, t is the point of time of the measurement. For exemplary calculations it was assumed that the focal area has a rotational symmetry around the optical axis within one arm of the interferometer. The focal region of one interferometer arm was regarded as a binary mixture of the buffer solution having a refractive index of about n_{H2O}=1.33, with particles like proteins having a refractive index of about n_{P}=1.5, resulting in a combined refractive index according to n_{M}=Φ_{H}_{₂}_{O}n_{H}_{₂}_{O}+Φₚnₚ, wherein Φ_{H}_{₂}_{O} and Φₚ are volume fractions of the two compounds. In addition, it is assumed that the light intensity distribution W(r) is invariant along the optical axis of an arm for dimensions smaller than the radius of the particles rₚ.

A collimated light beam can be generated by a light source and a first collimating lens arranged in the light path emanating from the light source, or, preferably by using a light source emitting collimated light, e.g. a laser and/or a mono-modal optical fibre. For measurement, the collimated light beam or split light beams are collimated for focusing onto a sample and, subsequent to passing through the sample, collimated and analysed by a wave front analyser. In embodiments comprising a light source emitting collimated and/or mono-modal light, a first collimating lens is dispensable, but for the purposes of the invention, the second focusing collimating lens is still termed second collimating lens. Preferably, the second collimating lens focusing the light beam or beams to define a sample volume by its focal area and focal distance, and the third collimating lens collimating the light after passing through the sample volume are microscope objectives.

Preferably, in the case of split beams e.g. generated by a beam splitter, the arms of the interferometer are introduced into the microscope objectives used as second and third collimating lenses, respectively, at a small angle, resulting e.g. in spatially separated foci In embodiments containing a first beam splitter, following the first beam splitter, one of the split beams, e.g. the split beam generated by reflection from the first beam splitter, is directed to the second collimating lens by a first reflector.

For detection, light being focused by the second collimating lens for passing through the sample and collimated by a third collimating lens, e.g. a microscope objective, is combined in a second beam splitter or combiner, with the irradiation resulting from the interference being directed to and detected by an optical detector. Preferably, a detector is arranged within the light path that is a nulled dark exit in an ideal undisturbed state, i.e. in the case without a sample interfering with the light path between the second and third collimating lenses. In this undisturbed state, the nulled or dark light path results from destructive interference. For a perfectly nulled interferometer, even very small disturbances of the coherence in one of the foci caused by refractive index fluctuations or absorption or non-linear effects like e.g. the optical Kerr effect will result in the detection of photons in the otherwise absolutely dark exit. Fluctuations in regions more remote from the focal region defining the sample volume basically have an identical effect on both arms of the interferometer and, consequently, have a much reduced influence on the measurement result. Especially in combination with a deep nulling depth, e.g. a very small numerical null, preferably at or below 10⁻⁴, preferably at or below 5×10⁻⁵, more preferably at or below 10⁻⁶, correlational analysis with high sensitivity can be performed. One reason for the light sensitivity is that no additional light source fluctuations causing artificial correlation signals is used. In addition, no modulation of the signals for lock-in amplification is necessary in the invention, avoiding its influence on correlational analysis. However, in the exit of the second beam splitter or combiner in which constructive interference occurs, i.e. the bright exit, a further detector may be arranged.

The arrangement according to the invention, using a collimated beam or two or more split beams, focused onto a sample, preferably using one or more microscope objectives as second and third collimating lenses, respectively, contains subsequent detection of the beam passing through the sample volume using a wave front analyser that is suitable for the detection of optical inhomogeneities, e.g. fluctuations of the refractive index of the sample. Preferably, the detection of refractive fluctuations is only limited by the diffraction of at least one of the collimating lenses, e.g. of a microscope objective. Optical inhomogeneities, e.g. fluctuations of the refractive index, can especially well be determined in the case of movements of a sample particle, resulting in a change of the refractive index relative to the measuring area, e.g. within the focusing area generated by the focusing of the light beams by the second collimating lens.

As a detector, a CCD camera, a photomultiplier or a light-sensitive semi-conductor element can be used.

The arrangement according to the present invention has the advantages of providing for a high sensitivity, a high spatial resolution and a high resolution in time in the measurement of small sample particles, structures or processes within a medium, e.g. particles, structures or processes within an aqueous and/or lipid and/or gaseous medium or of structural differences in at least partially optically transparent or translucent solids. When analysing solids, it is preferred to use an actuating mechanics for controllably moving the solid relative to the sample volume. As a particular advantage, no labelling of samples with a fluorescent dye, nor fluorescence of the sample itself is required, as well as no immobilization of the sample to a surface is necessary.

Further, the optics for generating the different split beams or beam sections are less complicated and more robust than those known in prior art devices.

Especially when using a very sensitive, deep nulling interferometer as a wave front analyser, the arrangement of the present invention can be used to analyse very small sample particles, even using light of a wide spectral band.

Further, the arrangement of the present invention allows to integrate optical nearfield apertures within the focal area of the collimating lenses, e.g. the microscope objectives, yielding a higher sensitivity.

Further embodiments of the device and process of the invention are defined in the claims, which are part of the disclosure of the present invention.

Further, it is of advantage that the arrangement of the present invention allows to analyse non-metallic nanoparticles and in that it is not limited to measurements with concurrent generation of temperature changes within the sample to be analysed. The analytical process to be performed using the arrangement of the present invention is suitable for analysis of non-metallic sample particles, e.g. for organic polymers, for instance lipids, protein, carbohydrates and combinations thereof in solution and/or in the form of crystals at temperatures between 0° C. and 50° C., including physiological temperatures, e.g. in the range of 20-37° C.

### DETAILED DESCRIPTION OF THE INVENTION

The present invention is now described in greater detail with reference to the figures, wherein

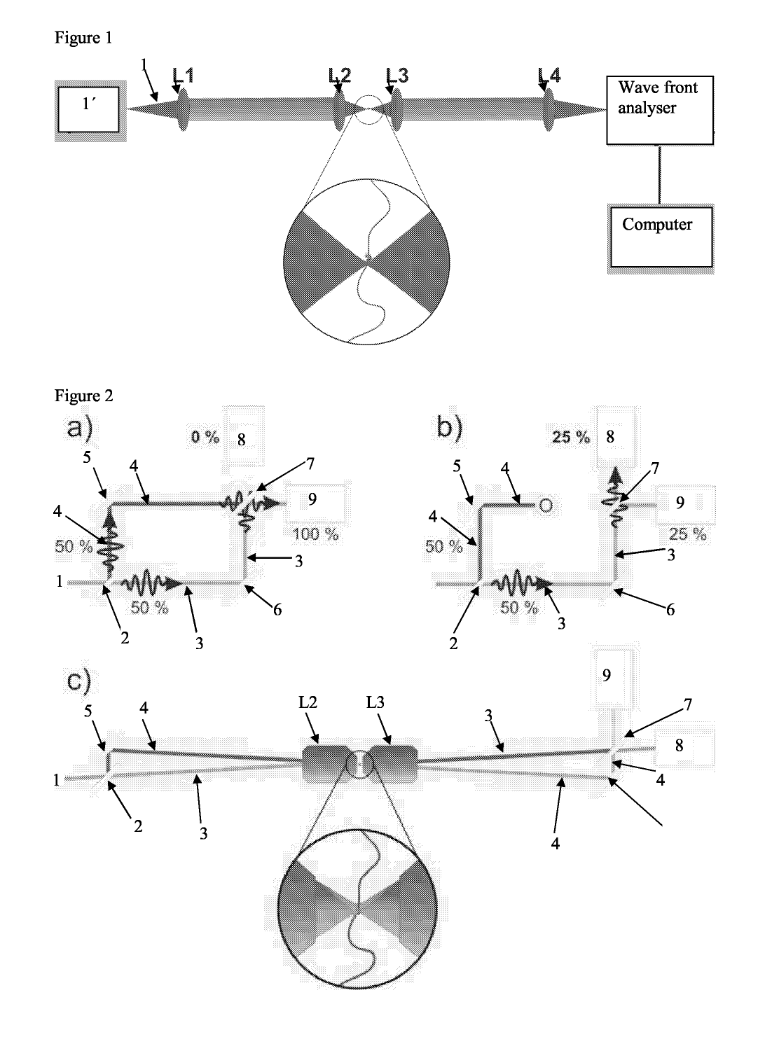

FIG. 1 schematically shows a first arrangement of the device according to the present invention,

FIG. 2a) schematically shows a device according to the present invention without a sample interfering with the light beams,

FIG. 2b) schematically shows the device according to the present invention in a state with a sample interfering with the light beam,

FIG. 2c) schematically shows one embodiment of the device of the invention with a sample particle,

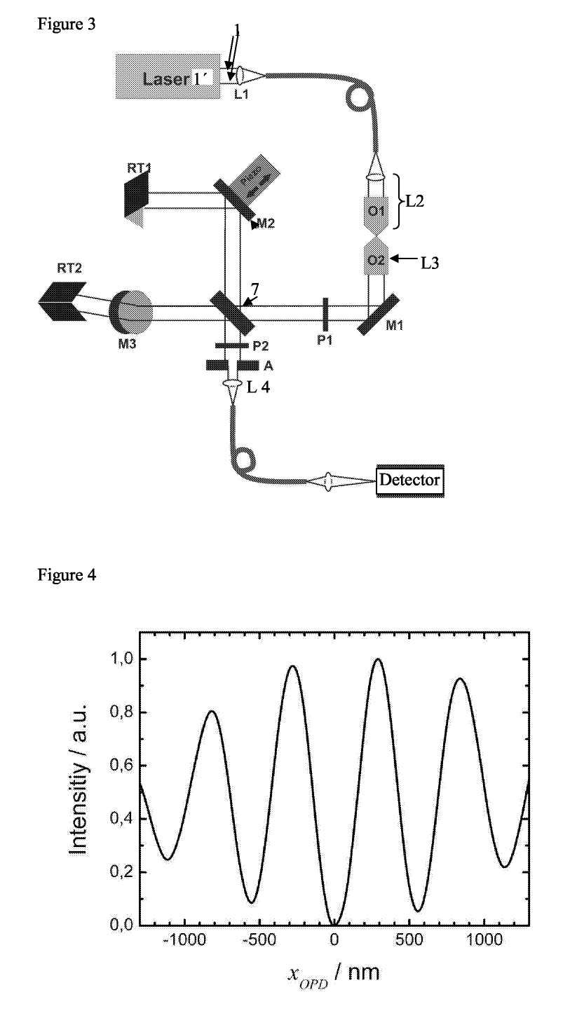

FIG. 3 schematically shows a preferred embodiment of the device according to the invention,

FIG. 4 shows the light intensity in arbitrary units at the nulled exit as a function of the optical pathway difference in a device according to the invention,

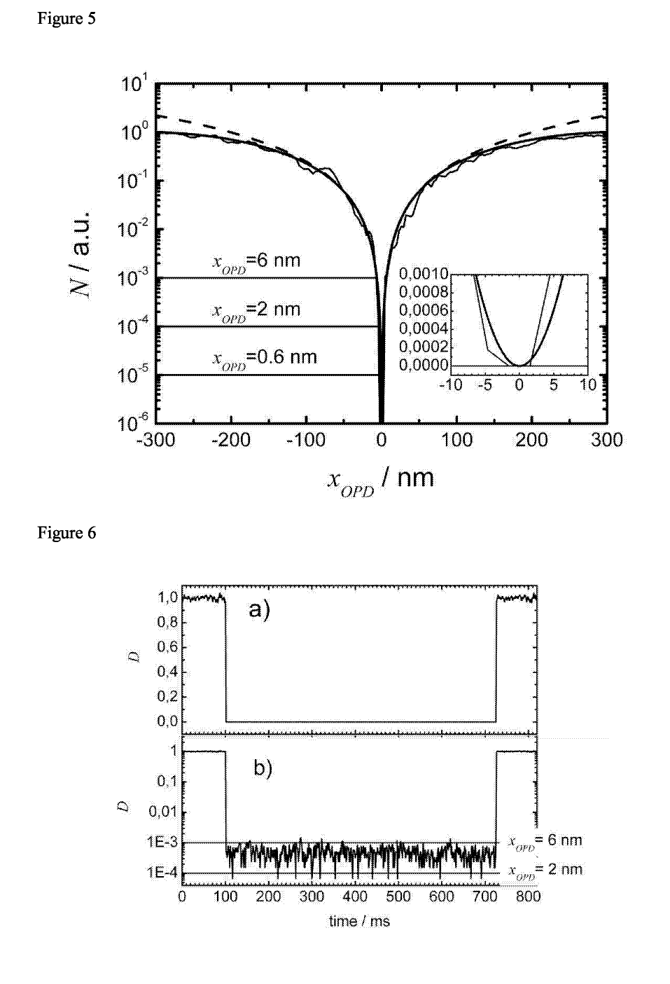

FIG. 5 shows normalized measurement results (thin erratic line) for the determination of null depth by scanning at the nulled exit in comparison to a calculated curve (solid black line) and an approximation (dashed line),

FIG. 6a) shows the stabilization of measurement results by computerised correlational analysis of measurement signals as a linear plot and under b) in a logarithmic plot, with the horizontal lines showing the necessary level of optical pathlength accuracy,

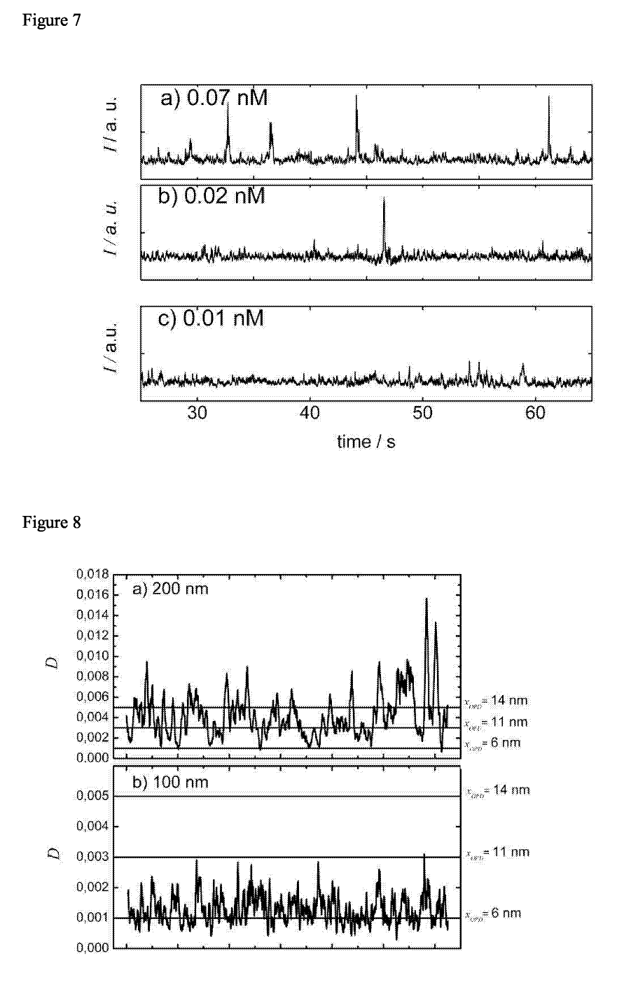

FIG. 7 shows deep nulling traces for a sample containing 200 nm polystyrene spheres measured in an arrangement according to FIG. 3, at concentrations under a) of 0.07 nM under b) of 0.02 nM), and under c) of 0.01 nM,

FIG. 8 shows fluctuational traces at λ=632 nm of a solution containing a) 200 nm spheres, b) 100 nm spheres at a concentration of about 1 nM corresponding to about an average of about 1 particle in the focal area, and c) pure buffer solution, and

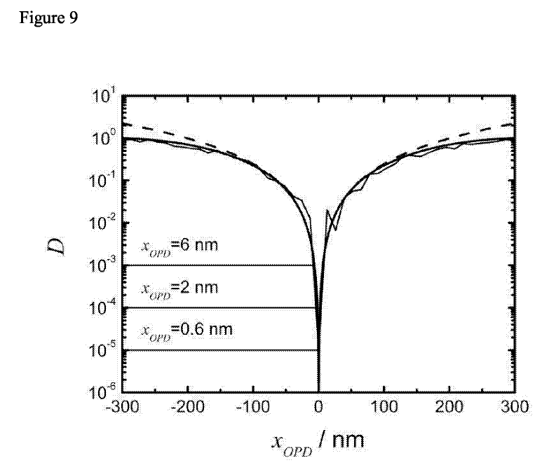

FIG. 9 shows normalized measurement results (thin erratic line) for the determination of null depth by scanning at the nulled exit in comparison to a calculated curve (solid black line) and an approximation (dashed line) in a device according to the invention using nearfield apertures for restricting the sample volume.

It is understood that in general in the schematic drawings, the light paths indicated can represent two of four quadrants, e.g. in embodiments employing a beam splitter.

Using the arrangements schematically depicted in FIGS. 1 and preferably 3, results are obtained showing that transient nulls on the order of 10⁻⁵ can be obtained in a microscope device of the invention with aqueous solutions, corresponding to optical pathway differences of less than 0.6 nm while actively stabilizing the nulls to about 5×10⁻⁴. These conditions allow a non-fluorescent fluctuational correlational analysis of biological samples, e.g. of the exemplary trimeric PS 1 protein having a diameter of about 10 nm or of the exemplary 20 nm diameter polystyrene spheres as well as single particle detection of larger particles, e.g. of the nanospheres having diameters of 100 nm and 200 nm, respectively, at constant temperature conditions. This level of stabilization allows to use the microscope device of the invention for fast correlational analysis of aqueous compositions, e.g. in the range of 1 s, and, preferably, the detection of real time diffusional transits of particles of a sufficient size through the focal area, e.g. through the sample volume defined by the focusing area. In further experiments, it could be shown that the deep nulling correlation curves are in good agreement with conventional two photon fluorescence correlation curves, providing evidence that the detection volume of the label free analysis method of the invention has a detection volume similar to that of state-of-the-art fluorescence methods, e.g. approximately a diameter of 200 nm and even below.

Further, the results show that the amplitudes of correlation curves obtained for non-fluorescent, i.e. fluorescence—label free sample particles provide additional information about the mass of the particles. Accordingly, in a preferred embodiment it is possible to perform diffusional and size analyses of biological samples such as vesicles, ribozymes, protein and DNA in microscopic dimensions without additional fluorescent or metallic label. Further, the device and method of the present invention can provide further data when exploring adsorption effects, e.g. using the Kramers-Krönig relation and/or the combination with non-linear optical techniques and/or using the optical Kerr effect. In greater detail, tilting the arms of the interferometer as e.g. shown in FIG. 2c) comprising first and second light paths generated by a first beam splitter which light paths are oriented in a small angle off their parallel and arranged to be received by the second collimating lens using a first reflector in one of the light paths can be used advantageously for the analysis of more complex sample compositions.

From theoretical considerations one can furthermore deduce that the device of the present invention is even more sensitive, preferably suitable for analysis of single biomolecules without fluorescence label when combined with a coherent nanometer nearfield source, e.g. generated by introduction of nearfield nano-apertures of about 20-50 nm size, preferably of about 30 nm size.

In a simple embodiment, the device according to the present invention is schematically depicted in FIG. 1, having a light source 1′ generating a light beam 1, which light source 1′ can generate light 1′ in the range of 200-900 nm, preferably in the visible range of 400-850 nm, comprising a range of wavelengths, preferably monomodal light, e.g. as a laser. The light 1 emitted from the light source 1′ is collimated in a first collimating lens L1 and focused by a second collimating lens L2. Accordingly, collimating lens L2 focuses the irradiation 1 emitted by the light source 1′, after optional collimation by first collimating lens L1, with the focal area of second collimating lens L2 defining the sample volume. Light 1 passing through the sample volume is collected by a third collimating lens L3 and focused by a fourth collimating lens L4 into a wave front analyser. Signals detected by the wave front analyser are fed into a computer for analysis of measurement signals obtained from the wave front analyser, preferably for correlational analysis.

The enlarged inset shows that a sample particle, schematically depicted as a thread, is interacting with focused light that has been collimated by second collimating lens L2. Following this interaction with light within the sample volume, the light is collimated by third collimating lens L3.

In greater detail, a further embodiment of the device of the present invention is schematically depicted in FIG. 2, wherein the light generated by a light source (not shown) is generally indicated as 1. In the schematic drawing, the light beam is split into two light paths, which may be realized as separate light paths, but which alternatively can be comprised within one collimated light beam 1. Accordingly, the split light beams and the collimated light beam, respectively are oriented to be received preferably by a common second collimating lens L2 for focusing. Less preferably, separate light paths are provided for each of the split beams. With reference to FIGS. 2a) to 2c), the incoming light beam 1 is split by a first beam splitter 2 by transmittance into a first light path 3 and by reflection into a second light path 4. The second light path 4 is reflected by a first reflector 5 to be oriented approximately parallel or in a small angle to a section of the first light path 3 and is directed onto a second beam splitter 7, which is also termed combiner or coupler. With reference to FIGS. 2 a) and b), a second reflector 6 is arranged within the first light path 3 to direct first light path 3 towards the second beam splitter 7. Accordingly, both the first light path 3 and the second light path 4 interfere at second beam splitter 7, namely destructive interference from transmittance of first light path 3 and reflection of second light path 4, which resultant light path constitutes the nulled or dark exit, within which first detector 8 is arranged. Constructive interference at second beam splitter 7 results from transmission of the second light path 4 through the second beam splitter 7 and reflection of the first light path 3 from beam splitter 7, which resultant light path is detectable in the bright exit, within which second detector 9 is arranged. The second collimating lens L2 is arranged to receive both the first light path 3 and the second light path 4 for focusing to generate the sample volume. Third collimating lens L3 is arranged to receive the light beams focused by second collimating lens L2.

Accordingly, first and second light beams 3 and 4 in this embodiment cross one another and the third collimating lens L3 is arranged behind the focal length of the second collimating lens L2, as schematically indicated in FIG. 2 c). This crossing of first and second light beams does not change the principle of destructive and constructive interference within or following second beam splitter 7 but results in an exchange of the dark and bright exits, and consequently, the preferred arrangement of a detector in the light path wherein destructive interference occurs following second beam splitter 7 can be made in a different exit of second beam splitter 7, which is the dark exit.

Alternatively and less preferred, the third collimating lens L3 can be arranged before the focal area of the second collimating lens L2, i.e. closer to second collimating lens L2 than the focal length of L2, therefore receiving first and second light beams 3 and 4 before they cross one another in the focus of L2, such that the first and second light beams 3 and 4 in contrast to FIG. 2 c) are oriented as shown in FIGS. 2 a) and b).

In general, the device of the invention preferably comprises an arrangement according to a Mach-Zehnder interferometer for detecting the fluctuations between the quadrants comprised in a light beam, e.g. as schematically by a first light path 3 and a second light path 4, generated by a first beam splitter 2. For detection, interference of the quadrants of the light beam is measured after passing through a sample volume, e.g. following interference at second beam splitter 7. Schematically, a first reflector 5 is arranged in the second light path 4 for reflecting the second light path 4 in parallel to or in a small angle to a section of the first light path 3 generated by transmission through first beam splitter 2, and a second reflector 6 is arranged in the first light path 3 to reflect the first light path 3 to interfere with the second light path 4 within second beam splitter or second coupler 7.

However, as also shown in FIGS. 1 and 3, physical presence of a first beam splitter is not always required. For example, embodiments using a collimated light beam, preferably of monomodal light, comprising the beam quadrants, can be focused to define the sample volume by a second collimating lens without first beam splitter 2 and without first reflector 5. The focal area is preferred for measurement because the most sensitive region of a beam quadrant with respect to fluctuations of the refractive index is very close to the focus of collimating lenses, e.g. microscope objectives. This is the area, in which the beam quadrants can just be optically separated, considering e.g. a diffraction limit of about 200 nm. The focal area can be determined by a three-dimensional optical transfer function defined by numerical apertures of the microscope objectives and by the position of the detector, e.g. an optical fibre receiving the light beam after the sample volume. In general, for each of the four beam quadrants, one such focal point in front of the focus and one after the focus is present, giving a total of 8 such focal areas.

The first detector 8 is arranged to receive the product of destructive interference, e.g. resulting from the second light path 4 being reflected by second beam splitter 7 with transmission of the first light path 3 through second beam splitter 7. Optionally, a second detector 9 is arranged at the bright exit of the second beam splitter 7, as depicted in FIG. 2 c) to receive the product of constructive interference of the first light path 3 being reflected by the second beam splitter 7 and of the second light path 4 being transmitted through the second beam splitter 7.

The device according to the invention comprises at least one second collimating lens L2 and one third collimating lens L3 which are arranged in one of the parallel or angled sections of the first light path 3 and/or of the second light path 4, the first and second light path 3, 4 schematically representing the beam quadrants. The second collimating lens L3 and the third collimating lens L3 are not indicated in FIGS. 2a) and 2b), but in FIG. 2c).

The ideal state of the Mach-Zehnder interferometer arrangement without any sample interfering with the light paths is schematically shown in FIG. 2a), resulting in a theoretical 100% constructive interference exiting second beam splitter 7 to be received by second detector 8, because the first beam splitter 2 ideally splits original light beam 1 into two identical halves of first light path 3 and second light path 4, resulting in complete destructive interference in the dark exit and, hence, no detectable signal for the first detector 8. The presence of a sample object interfering with the first light path 3 and/or second light path 4, as schematically shown in FIG. 2b), results in an alteration, e.g. a reduction of amplitude or increase or decrease of frequency of one of the first light path 3 and/or second light path 4 relative to one another and, accordingly, the interference at second beam splitter 7 is influenced, resulting in a reduction of the constructive interference exiting towards second detector 9 and to impairment of destructive interference at the nulled dark exit towards the first detector 8. Impairment of the destructive interference leads to the generation of a detectable light output signal at the dark exit of first detector 8. As in the dark exit even each single photon in the undisturbed state destructively interferes with itself, using the device according to the invention makes it possible to measure signals which are smaller than the shot noise of the measuring light field, yielding a high sensitivity for measurement of small sample inhomogeneities.

An embodiment of the original light beam 1 being split into a first light path 3 and a second light path 4 is schematically shown in FIG. 2c), wherein light beam 1 preferably is coherent light. The second collimating lens L2 is arranged within the parallel or slightly angled sections of the first light path 3 and of the second light path 4 to focus both light paths into a focal area, thus defining the sample volume. Irradiation passing through the sample volume, as is also shown in the enlarged circle, is collected by a third collimating lens L3. Schematically, a sample object is arranged in the focal point of both the first light path 3 and the second light path 4. From third collimating lens L3, first light path 3 and second light path 4 exit and can be introduced into a wave front analyser, e.g. schematically depicted as comprising a second reflector 6 and a second beam splitter 7 to allow the result of destructive interference of first light path 3 and second light path 4 to be introduced into first detector 8, and with the result of constructive interference to be introduced into optional second detector 9. Accordingly, this embodiment of the device is characterized in one second collimating lens L2 and one third collimating lens L3, both arranged in the first and second light paths 3 and 4, with the second collimating lens L2 and the third collimating lens L3 being formed to focus both the first light path 3 and the second light path 4 onto a sample volume and collecting light exiting from the sample volume, respectively, with a space for receiving a sample arranged between the second collimating lens L2 and the third collimating lens L3. It is preferred that at least one first detector 8 is present having a deep nulling depth is arranged to receive the result of destructive interference from light collected by third collimating lens L3.

A preferred embodiment of the device according to the invention is schematically shown in FIG. 3, wherein the light source is represented by a laser, generating light beam 1 which is collimated by first collimating lens L1. This embodiment also demonstrates that a first beam splitter in not a prerequisite of the device of the invention but an option, whereas the preferred realization of the wave front analyser requires a beam splitter, for the purposes of the invention still termed the second beam splitter, as a constituent part of the deep nulling interferometer.

Light passing through first collimating lens L1 can be collimated by second collimating lens L2, arranged within the light path of light exiting first collimating lens L1 or, as depicted in FIG. 3, an optical fibre may be arranged between first collimating lens L1 and second collimating lens L2 for guiding light exiting first collimating lens L1 to second collimating lens L2. The second collimating lens L2 may comprise further collimating lenses, e.g. in the form of a microscope objective O1 for focusing the light onto a sample volume. A third collimating lens L3, depicted here as a microscope objective designated O2, is arranged to receive light exiting from the sample volume. Following third collimating lens L3 (O2), there is arranged an interferometer as an embodiment of the wave front analyser.

The interferometer deletes diagonal quadrants of this single beam against one another, as long as the focal area of the collimating lenses L2, comprising microscope objective O1, and collimating lens L3, embodied here by microscope objective O2, remains without a fluid comprising or generating inhomogeneities e.g. no sample particle and no refractive index fluctuation is interfering with the light path within the sample volume. In this embodiment, elimination of diagonal quadrants of the collimated single beam is achieved by two orthogonal reflector pairs (rooftop mirrors), namely first orthogonal reflector pair RT1 and second orthogonal reflector pair RT2, each of the orthogonal reflector pairs RT1 and RT2 superimposing pairs of diagonal quadrants of the original light beam.

After being collimated by third collimating lens L3, light resulting from the pairwise superimposition of diagonal quadrants of the light beam by orthogonal reflector pairs RT1 and RT2, respectively, is detected in a detector. For guiding the light beam exiting third collimating lens L3 towards the two orthogonal mirror pairs RT1 and RT2, respectively, a second beam splitter 7 is arranged within the light path exiting third collimating lens L3. The second beam splitter 7 generates one split beam by partial reflection, which split beam is reflected by third reflector M2 arranged in its light path, preferably at 45°, and which is movable by a micromechanics for active adjustment, e.g. by a piezo actuator, to direct this split beam into orthogonal reflector pair RT1. Active adjustment is used for compensating fluctuations not resulting from sample fluid inhomogeneities, or for compensating fluctuations resulting from sample inhomogeneities for use of the degree of compensation as a measurement signal. From first orthogonal reflector pair RT1, the split beam is retro-reflected by reflector M2 onto the second beam splitter 7. After the beam splitter 7, one part of the beam quadrants is guided along M2-Rt1 and back in parallel to a first plane, e.g. a table, parallel to which first plane the second and third collimating lenses O1, O2 direct the light beam through the sample volume.

The split beam generated by passing of light through second beam splitter 7 by transmission is reflected by fourth reflector M3 into orthogonal reflector pair RT2, which second orthogonal reflector pair RT2 retro-reflects the split beam towards fourth reflector M3 and, subsequently, to second beam splitter 7.

Accordingly, the remaining part of the beam quadrants is reflected vertically to the first plane at the flat fourth reflector M3. This arrangement causes the electric field vector of the light beam reflected by the beam splitter 7 and reflector M2, and retro-reflected by first orthogonal reflector pair RT1, to be shifted by a turn of 180°.

Accordingly, it is preferred that the wave front analyser comprises a Mach-Zehnder interferometer arranged to rotate the E-vector of the light exiting the sample volume by 180° in one of its interferometer arms, e.g. by using orthogonal reflector pairs arranged to superimpose light beams generated by a beam splitter. Preferably, the orthogonal reflector pairs are arranged to retro-reflect the light beams generated by a beam splitter, one split light beam in perpendicular to the other split light beam. For the orientation of the split light beams in perpendicular to one another, reflectors are arranged in the split light beams generated by the second beam splitter, one reflector in perpendicular to the other reflector. For example, one reflector, e.g. a third reflector, can be arranged to reflect a first split beam at 90° within a first plane by being arranged perpendicularly to the first plane, e.g. within the plane in which second and third collimating lenses orient the light beam, the third reflector e.g. arranged in parallel to the reflective surface of the second beam splitter; the other reflector, e.g. a fourth reflector, can be arranged within the other split beam to orient the other split beam in perpendicular to the first plane, e.g. by being arranged in an angle of 45° with respect to the first plane. Accordingly, the reflectors constituting the orthogonal reflector pair arranged for retro-reflecting the light from third reflector, e.g. the reflectors of first orthogonal reflector pair Rt1, are each positioned in an angle of 45° to the first plane representing the median of the orthogonal reflector pair, whereas the reflectors constituting the other orthogonal reflector pair arranged for retro-reflecting the light from the fourth reflector, e.g. the reflectors of second orthogonal reflector pair Rt2 are positioned in a distance to the first plane, with a normal to the first plane forming the median of the second orthogonal reflector pair.

Alternatively, the orientations of third and fourth reflectors can be exchanged for one another, including an adaptation of the arrangement of the respective orthogonal reflector pairs for retro-reflecting the split beams onto the beam splitter while maintaining the rotation of the E-vector of the light by 180°.

As a consequence, an extremely efficient deletion of light, preferably of or better than 10⁻⁵ is achievable at the exit past fourth collimating lens L4, even for non-monochromatic light, in cases when the optical pathway difference is maintained exactly at 0, e.g. by an actively controlled piezo actuator arranged for controlling third reflector M2. The high efficiency of elimination can further be increased by introducing a first polarizer P1 within the light beam exiting third collimating lens L3, optionally in alternative to or in combination with the introduction of a second polarizer P2 within the light path resulting from interference of light retro-reflected from orthogonal reflector pairs RT1 and RT2, respectively, exiting from second beam splitter 7, preferably before fourth collimating lens L4. Further, the elimination can be increased by introducing an adjustable aperture within the light path of interfering light exiting second beam splitter 7.

As a result, when e.g. arranging a gaseous composition or a liquid medium, e.g. an aqueous buffer solution between second collimating lens L2, optionally including microscope objective O1, and third collimating lens L3, practically no photon is detectable in the dark exit, e.g. after fourth collimating lens L4, as long as no sample object is present in the focal area introducing an inhomogeneity into the sample fluid.

A first detector, e.g. a photomultiplier, can be arranged directly after fourth collimating lens L4, or alternatively, an optic fibre can be arranged to receive light exiting fourth collimating lens L4 to introduce the result of destructive interference to the first detector, optionally using an additional fifth collimating lens L5. The optic fibres indicated in FIG. 3 preferably are monomodal fibres. It is preferred to reflect the light beam exiting first collimating lens L3 in an angle of 45° by arranging a reflector M1 in the light path between third collimating lens L3 and second beam splitter 7.

Fourth reflector M 3 is preferably arranged in an angle of 45° to the split beam transmitted by second beam splitter 7.

For compensation of pathway differences between the second beam splitter 7 and the first orthogonal reflector pair Rt1 and the second orthogonal reflector pair Rt2, a quartz plate can be arranged within the light path between second beam splitter 7 and first orthogonal reflector pair Rt1, preferably between second beam splitter 7 and third reflector M2.

The device of FIG. 3 allows to provide for deep nulling as well as for nulling of a broad spectrum of light, e.g. up to 200 nm fwhm.

As a further embodiment, actuating of the mechanics to position third reflector M2 or fourth reflector M3 can be used for compensating for destructive interference that causes a detectable signal in a first detector arranged in the dark exit, i.e. in the light path where destructive interference occurs. Measuring the actuating force required, e.g. voltage in the case of a piezo actuator, for compensating a signal detected at the dark exit to restore complete destructive interference can accordingly be displayed or analyzed as a measure for the fluid inhomogeneity, e.g. for the size of a particle in the sample volume.

### EXAMPLE 1

### Wave Front Analyser Microscope

Following the schematic device arrangement of FIG. 3, a wave front analyser microscope was assembled using as a light source a home-built fs-titan:sapphire oscillator (wave length of 800 nm, 500 mW, <100 fs pulse width, 90 MHz), alternatively a HeNe-laser beam (wave length of 632.18 nm, 10 mW, Spindler&Hoyer, Göttingen, Germany), or a wolfram lamp as a white light source. Collimating lenses L2 and L3 were realized by water immersion microscope objectives O1, O2 (Uapo 40× and Uplaplo 60×, Olympus, Hamburg, Germany), but not significant differences in nulling depths were observed when using different combinations of microscope objectives. Depending on the light source, 20-40 μW were focused into the second collimating lens O1.

For steering the beam quadrants emerging from the third collimating lens O2, i.e. the second microscope objective, into the detector, a 3D piezostage (model P611, E664, PI-System, Karlsruhe, Germany) was used as an actuator for fifth reflector M1 (AHF Analysentechnik, Tübingen, Germany) and for O1. A quartz plate arranged in the light path between second beam splitter 7 and first orthogonal reflector pair was tilted slightly for fine adjustment of the group velocity dispersion.

Third reflector M2 was mounted on a piezo-transducer (2 mm travel, S303, E802, PI-System, Karlsruhe, Germany), combined with a micrometer stage controlled by a picomotor actuator (2.5 cm travel, NF831, NF8753, Newfocus, San Jose, USA).

As a detector, an avalanche photodiode (AQR-13, Perkin-Elmer, Dumberry, Canada) or a photomultiplier (R1464, Hamamatsu, Hamburg, Germany) connected to a photon counter (SR400, Stanford Research Systems, Sunny Valley, USA) were used.

A global null position was found for the whole setup using the picomotor actuator controlling M2 and the pulsed laser or the white light source. Then, fine adjustments were done with the piezo actuator carrying M2. The controller of the piezo crystal was computer-controlled to actively move M2 in response to photons detected by the detector, e.g. for maintaining destructive interference at a maximum.

As a variation of the device according to FIG. 3, a dichroic beam splitter (low pass 700 nm, AHF Analysentechnik, Tübingen, Germany) was inserted into the light beams following third collimating lens L3 (microscope objective O2) to direct sample fluorescence light collimated by O2 into a detector (avalanche photo diode AQR-13, Perkin Elmer, Dumberry, Canada) using an intermediate collimating lens for focusing. The signal from this detector could optionally be used for compensation or correlation analysis.

As a preferred variation, the sample volume is reduced for better resolution by using light, preferably coherent light, passed through two nearfield light sources, preferably by introducing nano-apertures into the light beam or split beams, e.g. arranging nano-apertures within light exiting the second collimating lens. Suitable nano-apertures can be provided in the form of defined nano-holes in a metal foil, e.g. two or more holes of 10-100 nm diameter, preferably of 20-70 nm, more preferably ca. 30-40 nm diameter. Such nano-apertures are e.g. obtainable by impacting a heavy ion onto the metal foil, optionally followed by etching and/or electric ablation.

### EXAMPLE 2

### Measurements Using the Wave Front Analyser Microscope

Using the wave front analyser microscope of Example 1, the following measurements were made:

Without a sample containing particles in the sample volume, the intensity at the nulled dark exit was measured in response to a full sweep of the piezo actuator carrying M2. The white light (about 600-800 nm) source was the wolfram lamp. The optical pathway difference x_{OPD} is shown in FIG. 4.

FIG. 5 shows the normalized results (thin erratic line) of countrate measurements at the nulled exit as a function of x_{OPD} with the necessary levels of pathway accuracy indicated by horizontal lines. As a sample, aqueous buffer (phosphate buffered saline, PBS) was used. The solid black line shows calculated values, the dashed line shows an approximation. In the inset (linear plot), it is shown that the transient null corresponds to two subsequent measured values of zero counts. The wavelength was 632 nm.

From FIG. 5, it becomes clear that transient nulls can be measured by scanning using an actuator to introduce a pathway difference within one arm of the interferometer arrangement, exemplified here by the piezo actuator of M2, preferably linearly over a range corresponding to the global null and the two nearest maxima. Without further effort, the device of the invention allows to achieve nulls in the order of 10⁻⁵ for an aqueous buffer solution (PBS) and, accordingly, deeper nulls are expected to be realizable with this device. From further data obtained, it can be concluded that nulls can be better than or equal to 5×10⁻⁵ for an aqueous buffer solution. According to

$$D = \frac{N}{{N}_{0}} = {cos}^{2} \frac{φ}{2} = {cos}^{2} \frac{{x}_{OPD} π}{λ} \approx {( \frac{{x}_{OPD} π}{λ} )}^{2} for small {x}_{OPD} ,$$

wherein N₀ is the number of incident photons, N is the number of photons at the dark exit (D), λ is the wavelength of the incident light and Φ=x_{OPD}π the phase error, a null better than 5×10⁻⁵ corresponds to a pathway accuracy of better than 1 nm. This is a length scale below typical protein diameters, which therefore allows the detection of protein, preferably larger protein complexes, and of cellular organelles and functions.

Using a dithering algorithm, the interferometer arrangement can be stabilized at a position as close as possible at x_{OPD}=0 nm. This stabilization is limited by the vibrational isolation of the system, which can be improved for better measurement accuracy of the device of the invention. With the current level of vibrational stabilization, stabilized nulls of about 5×10⁻⁴ can be realized, which correspond to a pathway accuracy of about x_{OPD}≈4 nm. Results of correlational analysis of measurement values are shown in FIG. 6, wherein under a) in a linear plot and b) a logarithmical plot the stabilization by the computer at a minimum x_{OPD}, corresponding to nulls of about D≈5·10⁻⁴ (100-720 ms) and at x_{OPD}=λ/2 (D=1, 0-100 ms and 720-820 ms). The horizontal lines indicate the necessary level of optical pathway accuracy. The sample was an aqueous buffer solution, λ was 632 nm.

Deep nulling measurements of polystyrene spheres having a defined 200 nm size in aqueous buffer suspension are shown in FIG. 7. Focal transits through the sample volume of individual 200 nm beads can be seen in the traces as peaks. In the most diluted sample, measured in FIG. 7c), only minor fluctuations caused by single particle transits more remote from the focal area were detected during the measuring time.

In FIG. 8, deep nulling measurements of polystyrene spheres of different diameters, a) 200 nm, b) 100 nm diameter, and c) buffer as a negative control are shown. The concentration of ca. 1 nM corresponds to an average of 1 bead per sample volume, which is defined by the focal area having a diameter of about 200 nm and having a length of about 500-1000 nm. This relation of particle concentration to sample volume is well suited for correlational analysis of the fluctuation signals. The half-width of peaks in the traces of ca. 75 ms for 100 nm spheres and of ca. 100-150 ms for 200 nm spheres correspond well to the average diffusional time measured by two-photon fluorescence correlation spectroscopy, supporting the accuracy of the measuring method of the invention.

Further, the measurements of FIG. 8 show that the amplitude of peaks corresponds to an additional optical pathway difference of xₙ˜10 nm for the 200 nm spheres and xₙ˜2 nm for the 100 nm spheres. These measured values match well to calculations of the additional pathway xₙ within the focal area one arm of the interferometer caused by the particle according to

$${x}_{n} = \frac{{\int }_{0}^{{r}_{p}} W ( r ) \cdot {x}_{s} ( r ) \cdot Δ n \cdot r \cdot d r}{{\int }_{0}^{∞} W ( r ) \cdot r \cdot d r} \\ = \frac{{\int }_{0}^{{r}_{p}} {e}^{- 2 \frac{{r}^{2}}{{r}_{0}^{2}}} \cdot 2 \cdot \sqrt{{r}_{p}^{2} - {r}^{2}} \cdot Δ n \cdot r \cdot d r}{{\int }_{0}^{∞} {e}^{- 2 \frac{{r}^{2}}{{r}_{0}^{2}}} \cdot r \cdot d r} , wherein$$

xₙ is the additional pathway, W(r) is the one dimensional light intensity distribution of this focal area, r is the radial distance from the optical axis, x_{S}(r) the optical path length of the light through the particle as a function of r, and Δn=nₚ−n_{H}_{₂}_{O}≈0.2 is the difference of the refractive indices of the particle and water. Assuming a Gaussian distribution for W(r) with r_{O} being the diameter of the focal region and a spherical function for x_{S}(r) with a radius of the spheres, rₚ. This calculation yields a value of xₙ=11 nm for a sphere of rₚ=100 nm radius and xₙ=1.6 nm for a sphere of rₚ=50 nm radius in a focal area of r_{O}=200 nm diameter. These values might be considered surprisingly small, but can be explained in that for a rₚ=100 nm sphere the maximum change of 40 nm in the optical pathlength is only obtained along a central axis while a large amount of light is passing by the sphere.

The deep nulling of the device according to FIG. 3 is improved by introduction of two 35 nm diameter holes in metal foil serving as nearfield apertures. The nearfield aperture was arranged in the focal region between the microscope objectives serving as second and third collimating lenses, respectively, using a 3D-micrometer stage for three-dimensionally adjusting the apertures. As a result, the sample volume could be reduced, allowing the detection of particles having dimensions in the range of a few nanometers, e.g. having the size of proteins and proteinacious and/or lipid complexes. Further, the nulling depth could be improved to lower values by the nearfield apertures, improving the sensitivity of the measurements. The measurement results are shown in FIG. 9.

### LIST OF REFERENCE NUMERALS

light beam 1
light source 1′
first beam splitter 2
first light path 3
second light path 4
first reflector 5
second reflector 6
second beam splitter 7
first (dark exit) detector 8
second (bright exit) detector 9
first collimating lens L1
second collimating lens L2
third collimating lens L3
fourth collimating lens L4
first orthogonal reflector pair Rt1
second orthogonal reflector pair Rt2
third reflector M2
fourth reflector M3
fifth reflector M1

1. Device having a light path for a light beam (1) generated by a light source (1′), a first collimating lens (L1) and a second collimating lens (L2) arranged for focusing the light beam (1) onto a sample, the focal area defining a sample volume, and a third collimating lens (L3) arranged for receiving light passing through the sample volume, characterized by a wave front analyser which is arranged to receive the light transmitted by the third collimating lens (L3), wherein the wave front analyser comprises a first detector (8) arranged in a light path of destructive interference from light collected by the third collimating lens (L3).

2. Device according to claim 1, characterized in that the wave front analyser is coupled to a computer capable of receiving measurement signals from the wave front analyser and displaying measurement data.

3. Device according to one of the preceding claims, characterized in that the light source (1′) and the first collimating lens (L1) are replaced by a light source (1′) disposed for emitting a collimated light beam (1).

4. Device according to one of the preceding claims, characterized in that a second beam splitter (7) is arranged to receive and combine the light paths (3, 4) exiting the third collimating lens (L3) and
wherein the first detector (8) is arranged in the light path following the second beam splitter (7) in which destructive interference of the first light exiting the third collimating lens (L3) occurs.

5. Device according to one of the preceding claims, characterized in that between the first collimating lens (L1) and the second collimating lens (L2) there is arranged a first beam splitter (2) to split the light beam (1) by partial transmittance into a first light path (3) directed onto the second collimating lens (L2) and by partial reflection into a second light path (4) with a first reflector (5) arranged within the second light path (4) to direct the second light path (4) onto the second collimating lens (L2).

6. Device according to one of the preceding claims, characterized in that a third reflector (M2) is arranged in the light path reflected from the second beam splitter (7) and a first orthogonal reflector pair (RT1) is arranged to retro-reflect the light path onto the third reflector (M2),
and a fourth reflector (M3) is arranged in the light path of light transmitted through the second beam splitter (7) and a second orthogonal reflector pair (RT2) is arranged to retro-reflect the light path onto the fourth reflector (M3),
and the detector is arranged following the second beam splitter (7) in the light path in which destructive interference of the light paths retro-reflected from the first orthogonal reflector pair (RT1) and retro-reflected from the second orthogonal reflector pair (RT2) occurs.

7. Device according to one of the preceding claims, characterized in that a fifth reflector (M1) is arranged at 45° in the light path exiting the third collimating lens (L3).

8. Device according to one of the preceding claims, characterized in that the third reflector (M2) is arranged in parallel to the reflective surface of the second beam splitter (7), reflecting the light path exiting from the third collimating lens (L3) and is arranged perpendicularly to a first plane to direct the light in parallel to the first plane, and the fourth reflector (M3) is tilted in an angle of 45° to the first plane to direct the light beam perpendicularly to the first plane.

9. Device according to one of claims 5 to 8, characterized in that a fifth reflector (M1) is arranged perpendicularly to the first plane and in an angle of 45° to the light beam exiting the third collimating lens (L3).

10. Device according to one of claims 5 to 9, characterized in that the third reflector (M2) and/or the fourth reflector is adjustably mounted on a parallel motion actuator.

11. Device according to one of the preceding claims, characterized in that the third collimating lens (L3) is spaced at a shorter distance from the second lens (L2) than the focal length of the second lens (L2).

12. Device according to one of the preceding claims, characterized in that at least two nearfield apertures having a diameter of 10-100 nm each are arranged in parallel within the light path following the third collimating lens (L3).

13. Process for analysing a fluid by measuring inhomogeneities within the fluid, characterized by using a device having a light path for a collimated light beam (1) generated by a light source, a second collimating lens (L2) arranged for focusing the light beam (1) onto a sample, the focal area defining a sample volume, and a third collimating lens (L3) arranged for receiving light passing through the sample volume, characterized by wave front analyser which is arranged to receive the light transmitted by the third collimating lens (L3), wherein the wave front analyser comprises a first detector (8) arranged in a light path of destructive interference from light collected by the third collimating lens (L3).

14. Process according to claim 13, characterized in that signals obtained from the first detector (8) are subjected to computerized correlational analysis.

15. Process according to one of claims 13 to 14, characterized in that destructive interference is generated by splitting the light exiting the third collimating lens (L3) in a second beam splitter (7) and retro-reflecting the split beams towards the second beam splitter (7) while turning the E-vector of one split beam by 180°.

16. Process according to one of claims 13 to 15, characterized in that the device comprises a third reflector (M2) and/or the fourth reflector (M3) arranged within light paths retro-reflected onto second beam splitter (7), which third reflector (M2) and/or the fourth reflector (M3) is adjustably mounted on a parallel motion actuator and actuating is used for actively adjusting the pathway difference between interfering light paths.

17. Process according to claim 16, characterized in that actuating for actively adjusting the pathway difference between interfering light paths is used to adjust for maximum destructive interference.

18. Process according to claim 16, characterized in that maximum destructive interference is adjusted during measurement of fluid inhomogeneities.

19. Process according to one of claims 13 to 18, characterized in that the fluid is a gas.

20. Process according to one of claims 13 to 18, characterized in that the fluid is a liquid.

21. Process according to one of claims 13 to 18, characterized in that the fluid is an at least partially translucent solid.

22. Process according to claim 21, characterized in that the solid is arranged on an actuating device and moved at predetermined speed through the sample volume.
